(19) United States
(12) Patent Application Publication
(10) Pub. No.: US 2014/0214590 A1
(43) Pub. Date: Jul. 31, 2014

(54) TECHNIQUES FOR DETERMINING SUBSTITUTES FOR PRODUCTS INDICATED IN AN ELECTRONIC SHOPPING LIST

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/754,782

(22) Filed: Jan. 30, 2013

(51) Int. Cl. G06Q 30/06

(52) U.S. Cl. CPC G06Q 30/0631
USPC 705/26.7

(57) ABSTRACT

Health related attributes of a consumable product can be used to propose substitutes for the product. A computer-implemented method to propose substitutes includes receiving from a user an original shopping list comprising the consumable product, determining health related attributes for the product, generating a proposed healthy choice substitute for the product based upon the health related attributes, and displaying the proposed healthy choice substitute to the user.

### BACKGROUND INFORMATION

1. Field of the Disclosure

The present invention relates generally to systems and methods for optimizing an electronic shopping list. In particular, examples of the present invention are related to techniques for determining substitutes to recommend for products indicated in an electronic shopping list based on health related attributes of the substitute.

2. Background

Consumers buy grocery products from a retail store for personal or family consumption. Health related details or health related attributes about consumer goods are readily known and digitally available. Such health related attributes can include but are not limited to calories per serving, fat per serving, carbohydrates per serving, sugar per serving, protein per serving, fiber per serving, and sodium per serving. Additionally, a percentage of a recommended daily allowance of important vitamins and minerals can be known about a product.

Experts in nutrition and dietary health publish and refine standards for healthy living. Recommended targets for daily consumption for a particular person can be determined or estimated, for example, based upon age, gender, activity level, and health history.

Consumers plan shopping trips to a retail store. A shopping list can be generated by the consumer listing products that the consumer plans to buy at the store. Consumers can create electronic shopping lists to aid in easily shopping for the desired products. Such electronic shopping lists can be easily viewed in a store through a portable computerized device, such as a smart-phone or a tablet computer. Alternatively, such a list can be generated upon a computerized device and printed upon a sheet of paper prior to the shopping trip. Stores can monitor and record a purchase history for a customer, for example, as tied to a particular credit card number. In another embodiment, a purchase history or other information can be stored in combination with a membership number, a customer phone number, or any other identifying information for a particular customer or family.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIGS. 1A-1C are schematics illustrating a portable computerized device displaying a graphical user interface in communication with a healthy choice substitution server, in accordance with some embodiments of the present disclosure;

FIG. 2 is a schematic illustrating components of an exemplary portable computerized device configured to provide proposed substitutions for a shopping list based upon healthy choices, in accordance with some embodiments of the present disclosure;

FIG. 3 is a schematic illustrating components of an exemplary healthy choices substitution server, in accordance with some embodiments of the present disclosure;

FIG. 4 is a schematic illustrating exemplary components of FIG. 3 with increased detail, in accordance with some embodiments of the present disclosure;

FIG. 5 is a flow chart illustrating an exemplary method to propose healthy choice substitutes for an original shopping list to generate an updated shopping list, in accordance with some embodiments of the present disclosure; and

FIG. 6 is a schematic illustrating operation of a one touch button and an aggressiveness slider for generating substitutes for an original shopping list, in accordance with some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Some consumers utilize capabilities of their portable computerized devices to prepare shopping lists. For example, a user of a computerized device may prepare an electronic shopping list containing one or more items that each indicate a different product that the user intends to purchase. The shopping list can be stored by the computerized device in advance of shopping to generate a print out the shopping list or to permit the list to be accessed by a portable computerized device and accessed while the user is shopping. In one embodiment, the list can be stored remotely on a server device, and a customer can access the list through any computerized device in communication with the server. As used herein, the term “portable computerized device” can refer to a number of computerized devices, such as smart-phones, laptop computers, and tablet computers. Users of portable computerized devices can store the shopping list on the portable computerized device and access the shopping list while shopping. Users of a stationary computerized device can print a paper copy of the shopping list or can send the shopping list to a mobile portable computerized device, either of which can be accessed while shopping.

In accordance with various embodiments of the present disclosure, techniques are described for generating electronic shopping lists. Furthermore, techniques are described for determining recommended or proposed substitutes for products appearing in the electronic shopping list based upon health related guidelines. As used herein, the term “substitute” can refer to one or more substitute products that can be substituted for a product indicated by an item in the electronic shopping list. Additionally, techniques are disclosed for generating an updated shopping list based on user selection or acceptance of one or more proposed healthy choice substitutes.

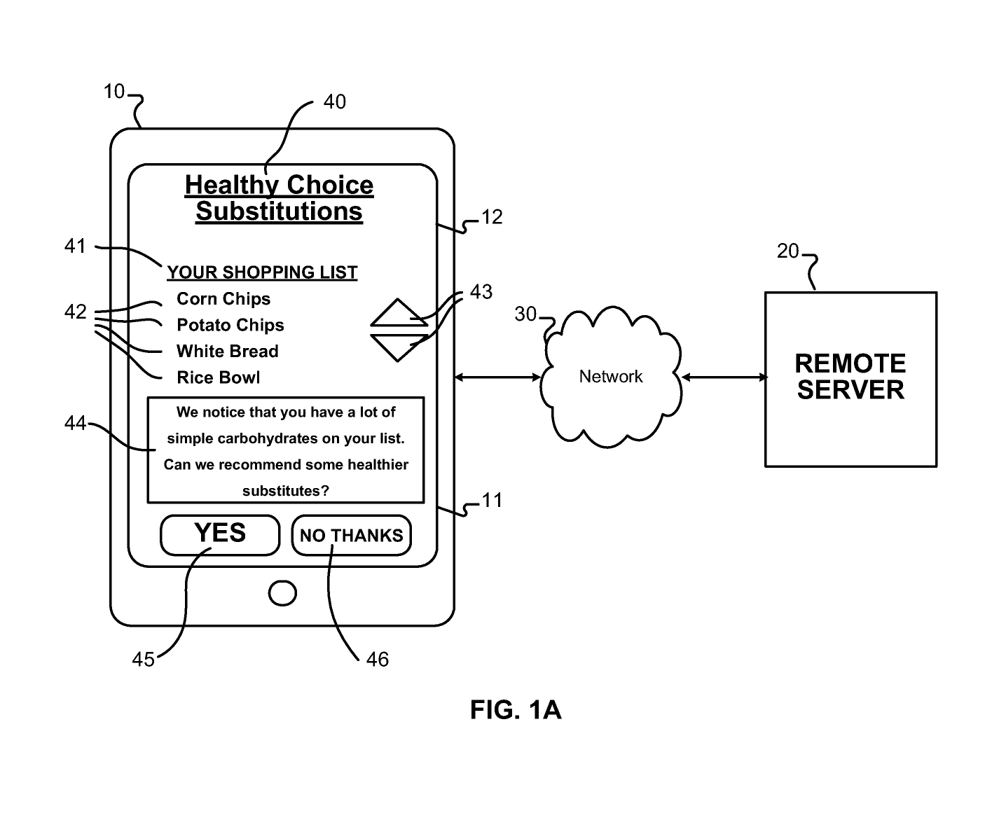

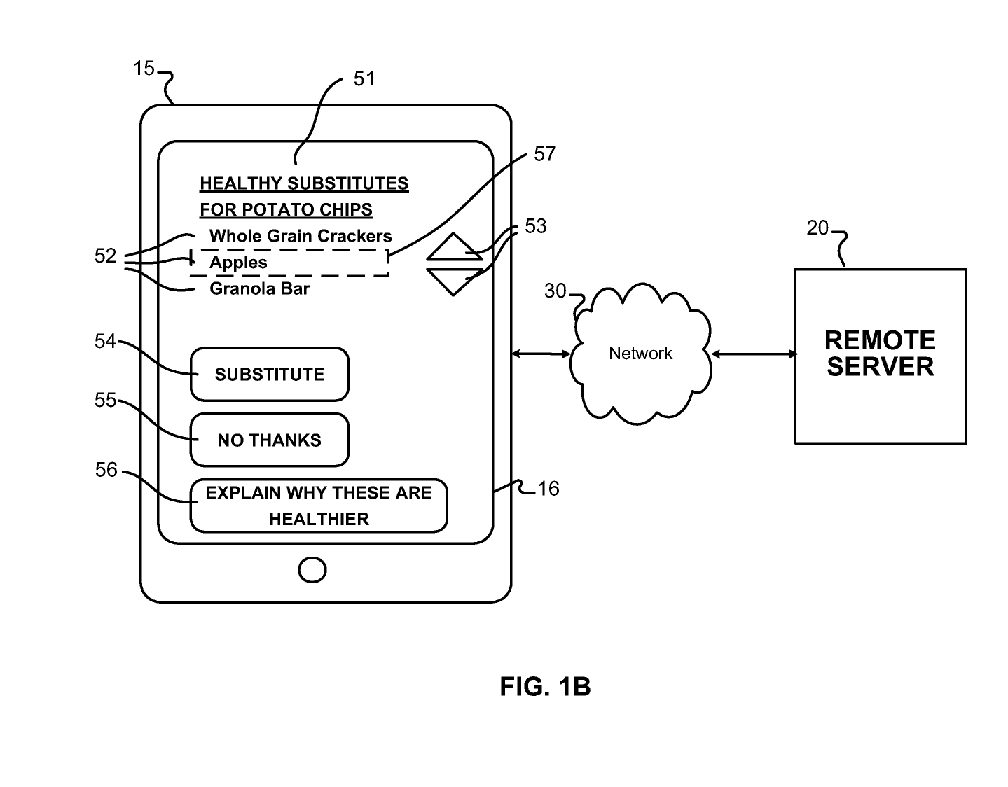

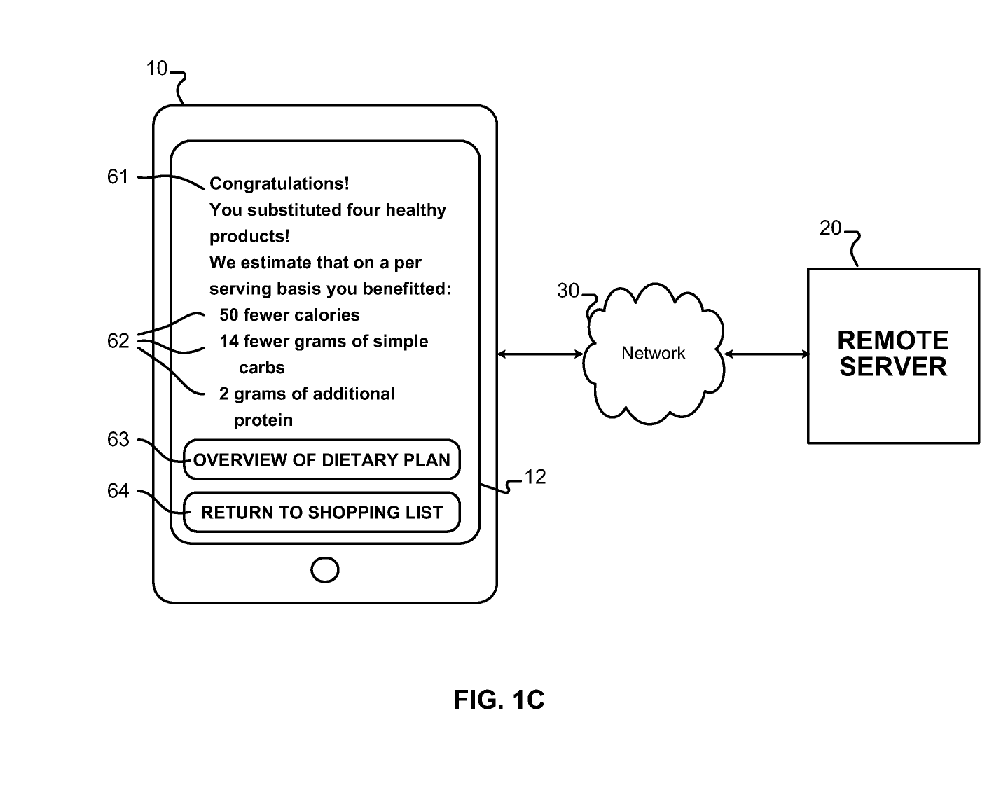

Referring now to FIG. 1A, a portable computerized device 10 in communication with a remote server 20 via a network 30 is illustrated. Portable computerized device 10 is embodied as an exemplary smart-phone. Remote server 20 can be referred to as a healthy choice substitution server. While one remote server 20 is illustrated, the term “remote server” refers to one or more servers that operate in an individual or distributed manner. Further, as used herein, the term “network” can refer to any communication network including, but not limited to, a wireless network, a cellular network, an intranet, the Internet, or combinations thereof. In the illustrated example, the portable computerized device 10 is displaying a graphical user interface (GUI) 12 on a touch screen 11 of the portable computerized device 10. While a touch screen 11 is illustrated, it should be appreciated that other user interfaces can be used to allow a user to interact with the portable computerized device 10.

In one embodiment, the GUI 12 allows a user to generate an electronic shopping list and to request a set of proposed healthy choice substitutes for the items listed in the electronic shopping list. The GUI 12 can display a banner 40 indicating to the consumer/customer that healthy choice substitutions are being offered, permitting the user to quickly recognize that a substitution mode has been activated. Buttons 45 and 46 permit the consumer to quickly accept or decline activation of the substitution mode, thereby minimizing an intrusiveness of the mode.

Activation of a substitution mode can be prompted by a number of events. The substitution mode can be manually activated by the consumer selecting an icon corresponding to a substitution application or program. The substitution mode can be manually activated as a selectable option within an application enabling generation of an original shopping list. The substitution mode can be selected by the consumer to automatically activate every time an original shopping list is generated. The substitution mode can be enabled as an application to quietly monitor original shopping lists as they are generated and provide an active suggestion, for example, a push notification, if a threshold number or threshold preference level of substitutions are identified. Methods of activation of a substitution mode can take a number of embodiments, and the disclosure is not intended to be limited to the particular exemplary embodiments provided herein.

GUI 12 can further display shopping list 41 including a plurality of particular consumable products 42 from the shopping list. Navigation buttons 43 can permit the consumer to scroll through and/or select items from the shopping list. A dialog window 44 can be displayed to inform the consumer, for example, why the substitution mode was activated and prompt selection of buttons 45 or 46 to initiate a list of proposed healthy choice substitutions or reject the substitutions, respectively. In some embodiments, the button 45 is a “one-tap” button. A “one-tap” button is a button that when selected by a user, automatically sends the request and the entire original shopping list to the remote server 20 without any additional confirmation from the user. In other embodiments, the portable computerized device 20 may present additional menus to the user, such that the menus prompt the user to select which items to send to the remote server 20.

The remote server 20 can receive the original shopping list and the request and can determine a set of candidate substitutes for each item included in the original shopping list. In some embodiments, the remote server 20 can provide recommended substitutes for a portion of the items. For example, the remote server 20 may be unable to determine an acceptable substitute for an item, and therefore, may not provide recommended substitutes for the item. In other embodiments, the remote server 20 may selectively choose which items to provide recommended substitutions for based on user settings or past user preferences. For example, if a consumer user may have entered that someone in the family is allergic to nuts, and therefore remote server 20 is blocked from providing any candidate or proposed substitutes that include nut ingredients. In another example, if the remote server 20 has provided bananas three times as a proposed substitute for a candy bar, and the user has rejected the substitute in each instance, the remote server can remove bananas as a potential candidate healthy choice substitute or can offer bananas less frequently based upon the previous non-acceptance. If a product is frequently accepted as a substitute for one type of item but rarely accepted as a substitute for another type of item, then the remote server 20 can adapt proposed healthy choice substitutes accordingly. Such adaptive methods can be implemented by programming methods known in the art, for example, including machine learning algorithms, wherein iterative results of operation of a program are used to train weight modifiers within the algorithm to adjust or adapt future operation of the program. Operation of such programming including machine learning algorithms is known in the art and will not be discussed in detail herein.

A list of candidate substitutes can be filtered based upon a number of criteria to determine a list of proposed substitutes to provide to the user consumer. For example, if twenty different candidate substitutes are identified in a substitution database 323, a top three list of candidate substitutes can be identified as proposed substitutes based upon some health related property. In one example, calories per serving can be used to rank candidates. In another example, fat content can be used to rank candidates. Candidates can be sorted according to a single property or set of properties, individually for each item on an original shopping list. In another embodiment, a group of items from a shopping list can be provided recommendations based upon balancing a number of characteristics. For example, some items with carbohydrates can be proposed along with other items high in protein and other items high in fiber. In such a balanced method, a shopping list could be allocated a number of points in each of a number of categories, and as items are selected with the properties, the points can be exhausted and later items to be proposed can be limited based upon the exhausted points in the different categories. Categorical criteria can be used to propose substitutions. For example, if the user does not have any green vegetables on the original shopping list, a side item such as baked beans could include a proposed substitution of asparagus based upon a priority given to green vegetables. In another example, if a customer is buying a white wine, a suggestion to click on a link to an article talking about the health benefits of red wine could be displayed to the user. A number of criteria for prioritizing different items as proposed substitutions are envisioned, and the disclosure is not intended to be limited to the particular exemplary embodiments provided herein.

Upon receiving the sets of recommended substitutes from the remote server, a portable computerized device can display each set of recommended substitutes in the GUI, thereby allowing the user to select one or more recommended substitutes for one or more of the items. FIG. 1B illustrates an example of a portable computerized device embodied as a tablet computer displaying a list of proposed substitutes for an item from an original shopping list. Portable computerized device 10 is communication with remote server 20 through network 30. In the illustrated example, the portable computerized device 15 including GUI 16 is displaying a banner message 51 describing a current item currently being proposed for substitution, in this example, potato chips. Three proposed substitutions 52 are illustrated. The displayed proposed substitutions can be ranked by position, for example, with a highest ranked substitution being listed first on the list. Buttons 53 are illustrated, for example, permitting a user to scroll through a set of proposed substitutions 52 or to select from the list of proposed substitutions 52. Selection box 57 is illustrated around an item, apples, from proposed substitutions 52. Button 54 is provided to permit the user to accept a proposed substitution, such that an updated shopping list will include, in this example, the potato chips deleted from the list and the selected apples added to the list. Button 55 is provided to permit the user to reject the proposed substitutions, for example, permitting the user to proceed to a next item from the original list and new list of proposed substitutes or to exit the substitution mode. Button 56 is provided to permit the user to request details regarding why the proposed substitutions are provided as healthier alternatives to the item from the original list. In one example, nutritional data used to select the proposed substitutions can be compared to similar nutritional data for the item from the original list. In another example, a plurality of stored nutritional articles or informational pages can be accessed, and a most relevant article describing health benefits of certain nutritional guidelines can be presented to the user. Other information can be presented upon GUI 16, for example, providing a price difference of the various substitutions to the original item or a running tally of how much the substitutions have affected the overall price of the shopping list.

FIG. 1C illustrates an exemplary portable computerized device providing positive feedback to the consumer user regarding the cumulative effect of the substitutions selected for an updated shopping list. Portable computerized device 10 is illustrated including GUI 12. Device 10 is communication with remote server 20 through network 30. Banner 61 is illustrated, providing an overall message regarding the substitutions made by the user. A summary including specific details 62 of benefits achieved through accepted substitutions are displayed. In this example, per serving totals of reduced calories, reduced simple carbohydrates, and increased protein are illustrated. Button 63 is provided to permit the user to review an overview of dietary plan being used to generate the proposed substitutions. Button 64 is provided to permit the user to exit the substitution mode and return to the shopping list.

Once the user has finished generating the updated shopping list, the portable computerized device can store the updated shopping list in memory or the list can be forwarded to a remote server, for example, to be accessed later. The remote server can utilize the updated shopping list to track the user's substitutions and/or to provide a follow-up survey requesting a rating of the acceptability of the substitution for the product indicated by the originally provided item.

A customer user will be more likely to use an application if it provides useful information without being intrusive, cumbersome, or otherwise irritating. The applications or methods disclosed herein for providing healthy choice substitutions for consumable products can be provided to include adjustable parameters for implementing suggestions. For example, specific limits can be placed upon the application such that a maximum number of items from the original shopping list can be suggested for substitution. A “not this shopping trip” button can be provided to initiate a sleep mode in the application ignoring a presently planned shopping trip. A user can limit degrees of change that the application can suggest, for example, permitting the application to suggest low fat potato chips in place of regular potato chips, but not permitting the application to suggest carrot sticks in place of the potato chips. A user deciding to put more effort into a diet can increase limits of what the program can suggest. The application can infer that some items are not eligible for substitution, for example, if substitutions are offered several times to an item, and each time the substitutions are rejected, the application can cease to offer proposed substitutions for the item or can prompt the user “Should I stop offering substitutions for this item?” Rules or preferences for how aggressively the application should offer substitutes or other recommendations can be stored in a customer negotiations preferences database within remote server 20.

The examples of FIGS. 1A-1C are provided for example only and not intended to be limiting. It should be appreciated that variations of the GUI are contemplated and are within the scope of the disclosure. Furthermore, while a portable computerized device is depicted, the computerized device can be a stationary computerized device as well.

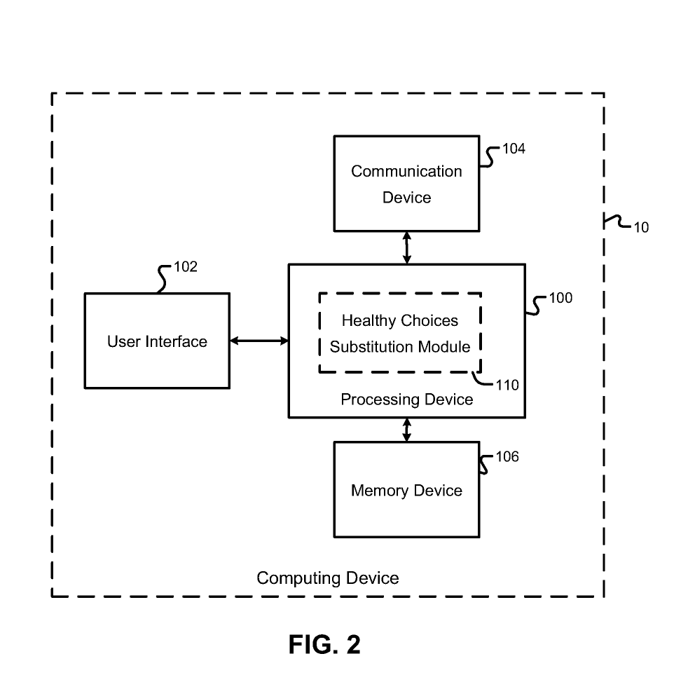

Referring now to FIG. 2, a block diagram illustrates exemplary components of a portable computerized device configured to operate according to the methods disclosed herein. Portable computerized device 10 includes a processing device 100, a user interface 102, a communication device 104, and a memory device 106.

The processing device 100 can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 100 can execute the operating system of the portable computerized device. In the illustrative embodiment, the processing device 100 also executes healthy choices substitution module 110, which is described in greater detail below.

The user interface 102 is a device that allows a user to interact with the portable computerized device 10. While one user interface 102 is shown, the term “user interface” can include, but is not limited to, a touch screen, a physical keyboard, a mouse, a microphone, and/or a speaker. The communication device 104 is a device that allows the portable computerized device 10 to communicate with another device, e.g., the remote server 20, via the network 30. The communication device 104 can include one or more wireless transceivers for performing wireless communication and/or one or more communication ports for performing wired communication. The memory device 106 is a device that stores data generated or received by the portable computerized device 10. The memory device 106 can include, but is not limited to a hard disc drive, an optical disc drive, and/or a flash memory drive.

In some embodiments, the healthy choices substitution module 110 is embodied as processor-executable instructions stored in the memory of the processing device 100. The processing device 100 can execute the healthy choices substitution module 110. The healthy choices substitution module 110 can be preloaded into the operating system of the portable computerized device 10, can be downloaded from a third party server by a user of the portable computerized device 10, or can be generated on the portable computerized device 10.

The healthy choices substitution module 110 provides graphics to be projected upon the GUI 12 and receives user input used to make the user selections disclosed herein. The healthy choices substitution module 110 further receives commands to request recommended substitutes from the remote server 20. In response to receiving sets of proposed substitutes from the remote server 20, the healthy choices substitution module 110 displays the sets of proposed substitutes corresponding to their respective items in the GUI 12 and receives user input indicating a selection of one or more of the proposed substitutes. The healthy choices substitution module 110 replaces the selected proposed substitutes for the corresponding items, thereby creating the updated shopping list. The healthy choices substitution module 110 can store the updated shopping list in the memory device 106, which can be accessed by the user at a later time. It should be appreciated that the healthy choices substitution module 110 may be configured to perform additional functions without departing from the scope of this disclosure.

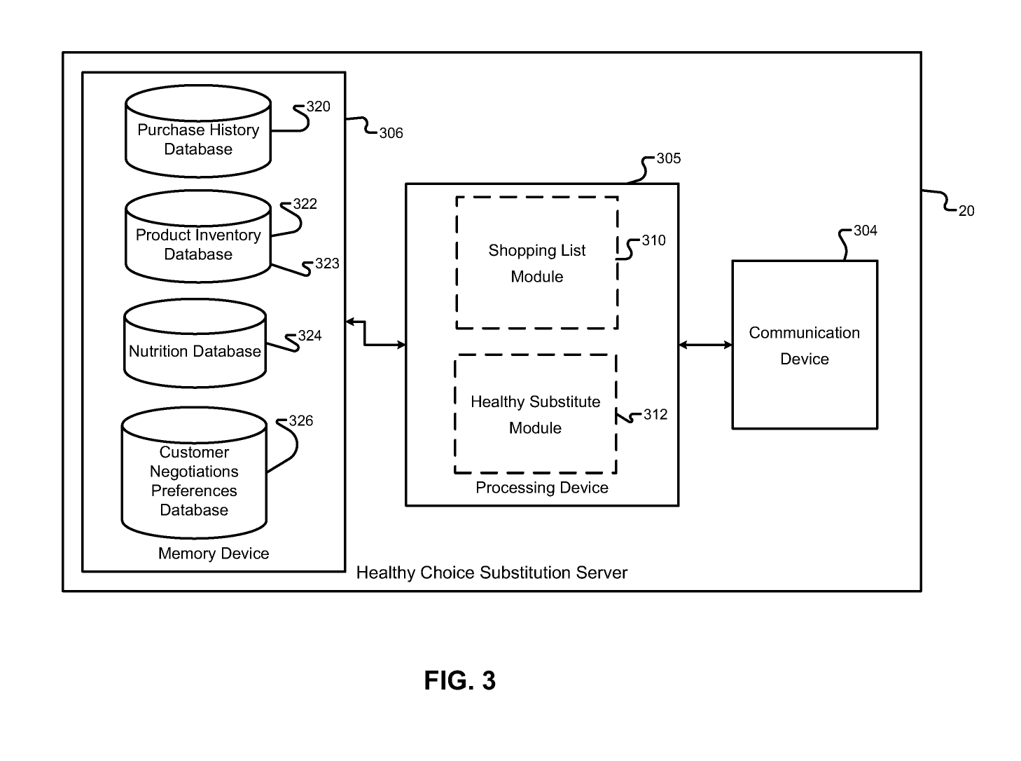

Referring now to FIG. 3, a block diagram illustrating an exemplary remote server 20 is depicted. In an exemplary embodiment, the remote server 20 includes a processing device 305, a communication device 304, and memory device 306.

The processing device 305 can include memory, e.g., read only memory (ROM) and random access memory (RAM), storing processor-executable instructions and one or more processors that execute the processor-executable instructions. In embodiments where the processing device 305 includes two or more processors, the processors can operate in a parallel or distributed manner. In the illustrative embodiment, the processing device 305 executes a healthy substitute module 312 and a shopping list module 310, which are described in greater detail below.

The communication device 304 is a device that allows the remote server 20 to communicate with another device, e.g., a portable computerized device, via the network 30. The communication device 304 can include one or more wireless transceivers for performing wireless communication and/or one or more communication ports for performing wired communication.

The memory device 306 is a device that stores data generated or received by the remote server 20. The memory device 306 can include, but is not limited to a hard disc drive, an optical disc drive, and/or a flash memory drive. The memory device 306 is accessible to the processing device 305. A substitution database 323, or a similar structure, can be stored in the memory device 306. In one embodiment, the substitution database 323 can be part of a product inventory database 322. In an exemplary embodiment, a retailer maintains the remote server 20, such that the items and the substitutions corresponding thereto are all indicative of products offered by the retailer. Alternatively, the remote server 20 can be maintained by a third party or a party affiliated with the retailer.

The substitution database 323 stores potential substitutes for a plurality of different items. In some embodiments, an item is related to one or more potential substitutes for the item. A potential substitute indicates one or more substitute products that could serve as a substitute for the product indicated by item. Candidate substitute items can be identified manually, for example by a nutrition expert with knowledge of substitutions that are most successful with average consumers. In another embodiment, a machine learning algorithm or similar programming can be used to identify substitutions that are most likely to accepted for average consumers, for consumers of a particular demographic, or for consumers in a particular geographic region. A nutrition expert and a machine learning algorithm can be used in coordination, for example, with an expert reviewing the learning of the algorithm, making correction to the suggestions made by the algorithm, or defining certain suggestions as inappropriate, for example, for a particular aggressiveness level selected for the algorithm. Additionally, purchase history for the particular consumer can be used to create a list of candidate substitutions. In another embodiment, a consumer can program his or her own substitutes, for example, indicating that when the consumer asks for donuts, the healthy choice substitution application should offer to substitute instant oatmeal for the donuts. Some products are sold as a combination of other products, for example as part of a recipe. For example, a taco kit may include tortillas, taco seasoning, and salsa. A recipe/complex entree can be offered as a proposed healthy choice substitute recipe for an item or group if items on a list. For example, a recipe and the required ingredients for tuna casserole could be offered as a substitute recipe for ingredients that would be used to make lasagna. Candidate substitutes can be determined for each item stored in the substitution database 323 in any suitable manner.

The substitution database 323 also stores attributes for each of the candidate substitutes. As discussed, an attribute can be any property of the substitute product indicated by the potential substitute. A non-exhaustive list of attributes includes health related attributes as discussed herein, a substitute cost of the substitute product, a cost difference between the substitute product and the product indicated by the item to which the potential substitute is related, a quality rating, a cost per unit, e.g., price per pound or fluid ounce, or a cost difference per unit.

Purchase history database 320 stores information related to a consumer's purchase history. This purchase history can be analyzed to determine preferences and tendencies of the consumer. According to one embodiment, these tendencies can be used to propose substitutes more likely to be accepted. In another embodiment, the tendencies can be used to provide helpful hints to the consumer, for example, recognizing that the consumer buys a large amount of butter and educating the consumer about the availability of similar, more healthy products that can be substitutes for butter.

Customer negotiations preferences database 326 can store information related to the intended or desired behavior of the healthy choices application. These preferences can be accessed by shopping list module 310 and healthy substitute module 312 to determine, for example, how frequently to offer substitutions and how diverse the proposed substitute can be from the original item.

Attributes for a particular product or a class of products can be collected in any suitable manner. Health related metrics can be entered as part of the information about a product stored in the product inventory database 322. Cost-related attributes can be provided by the retailer or calculated from other cost-related attributes. Some of the attributes can be learned using machine learning algorithms.

Details about the health related metrics of a product, such as calories per serving and percentage of recommended fat in a daily diet, can be stored as part of a product file in the product inventory database. In the alternative, the details can be stored in nutrition database 324. In addition to storing particular details of individual products or classes of products, nutrition database 324 can store and make available rules or algorithms for identifying healthy choice substitutes and for helping the consumer to make healthy choices.

The shopping list module 310 can coordinate creation and review of an original shopping list. In an event that the substitution mode is deactivated, shopping list module 310 can be used by the consumer to generate a shopping list and store it for later use. In one exemplary embodiment, module 310 can coordinate review and updating of the original shopping list with healthy choices substitution module 110. Shopping list module 310 can identify items or groups of items from the original shopping list most likely to be accepted for substitution or with the highest calories/potential for healthy substitution. Shopping list module 310 can disqualify particular items from proposed substitution, for example, identifying that a birthday cake probably has a specific purpose, and that the consumer will be unlikely to want to substitute broccoli for a cake intended for a family member's party.

The healthy substitute module 312 receives a shopping list or a items from a shopping list for potential substitution. Healthy substitute module 312 refers to the product inventory database 312, substitution database 323, purchase history database 320, and customer negotiations preferences data base 326 to process items from an original shopping list, identify candidate substitutes for some or all of the items, and generate proposed healthy choice substitutes based available data. In some embodiments, a set of proposed substitutes for an item can be an empty set if the healthy substitute module 312 is unable to identify any adequate substitutes for the item.

It is appreciated that the foregoing example of the remote server 20 is not intended to be limiting. Variations of the exemplary remote server 20 are contemplated and within the scope of the disclosure. For example, the memory device 306 may store a look-up table or a hash table that relates items to potential substitutes.

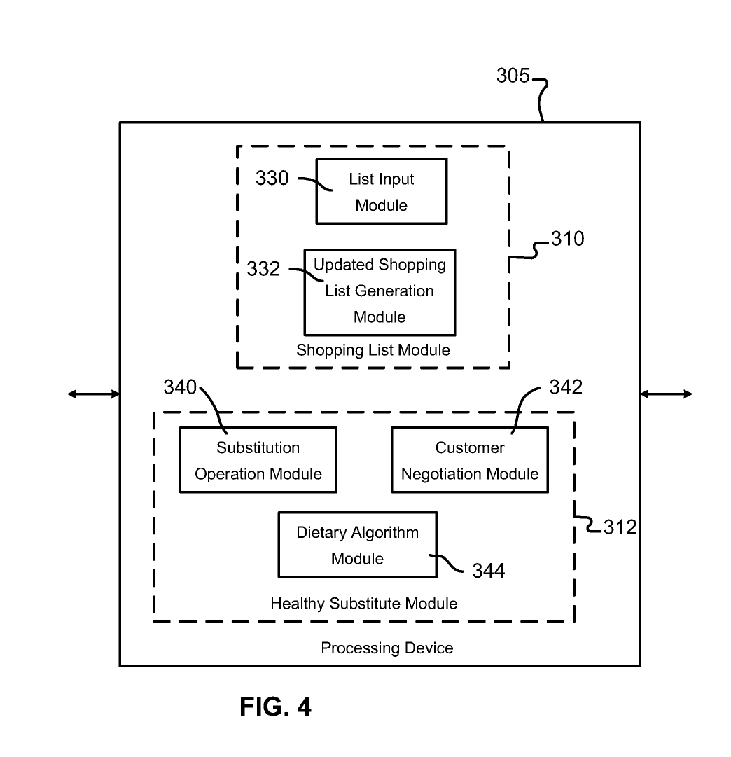

Referring now to FIG. 4, one particular exemplary embodiment of processing device 305 and included shopping list module 310 and healthy substitute module 312 are illustrated. Shopping list module 310 includes a list input module 330 in communication with a computerized device generating an original shopping list. List input module 330 can reference production information database 322 and identify particular product files for ambiguous items on the original list. List input module 330 can additionally determine likely items that can be grouped, for example, grouping a quart of ice cream and a bottle of hot fudge sauce as a single item to be proposed for substitution. Updated shopping list generation module 332 receives an original shopping list or a processed original shopping list from module 330 and coordinates with healthy substitute module 312 to generate an updated shopping list to provide to the consumer.

Healthy substitute module 312 includes a number of modules that together review items, determine health related attributes for the items, and generate proposed healthy choice substitutes for the items. Substitution operation module references items provided by module 310 and accesses the various databases of memory device 306 to apply methods disclosed herein to generate a list of proposed substitutes to the consumer. Dietary guidelines and nutritional information can be stored in the databases of memory device 306.

In one embodiment, a dietary algorithm module 344 can be employed to perform more complex analysis of a consumer's diet and associated shopping lists. Dietary algorithm module 344 can directly provide input to substitution operation module 340 or can monitor and alter health related guidelines stored within memory device 306. In one example, if a study comes out that trans fats are newly determined to be generally bad for people's health, algorithm module 344 can process the product inventory database to increase a likelihood that a product including trans fats will be recommended with substitutions and eliminate products including trans fats from lists of candidate substitutions. In another example operation of dietary algorithm module 344, a consumer can elect to enter verbatim meals eaten through a series of days, and dietary algorithm module 344 can compare the comprehensive list of meals to recommendations of health professionals. In another example, the consumer can elect to provide body weight measurements over a time span, and the dietary algorithm module 344 can aid the consumer to notice patterns in the data, e.g., shopping patterns that aid the consumer in maintaining a healthy weight. In one example, a consumer could receive a message, “We notice that you have a pound of cheese on your shopping list. According to your weight history, you tend to gain weight on weeks that you buy large amounts of cheese and you tend to lose weight the weeks that you do not buy cheese. Can we delete the cheese from your list or suggest a healthier substitute?” In one embodiment, wherein the consumer elects to participate in a social health group wherein participants share and reinforce each other in healthy activities, shopping lists can be processed or awarded points based upon healthy living criteria, and dietary algorithm module 344 can output the results of the processing to a remote server associated with the social health group for sharing with others in the group. Any number of dietary plans or regimens can be programmed into dietary algorithm module 344, and the disclosure is not intended to be limited to the particular exemplar embodiments provided herein.

Customer negotiation module 342 coordinates with the computerized device of the consumer to present proposed substitutions to the consumer and identify the responses of the consumer. In one embodiment, customer negotiation module 342 can provide the consumer with an ability to provide feedback, guidelines, rules, or other preferences regarding operation of the healthy choices application. Customer negotiation module 342 can reference and store information in the customer negotiations preferences module 326.

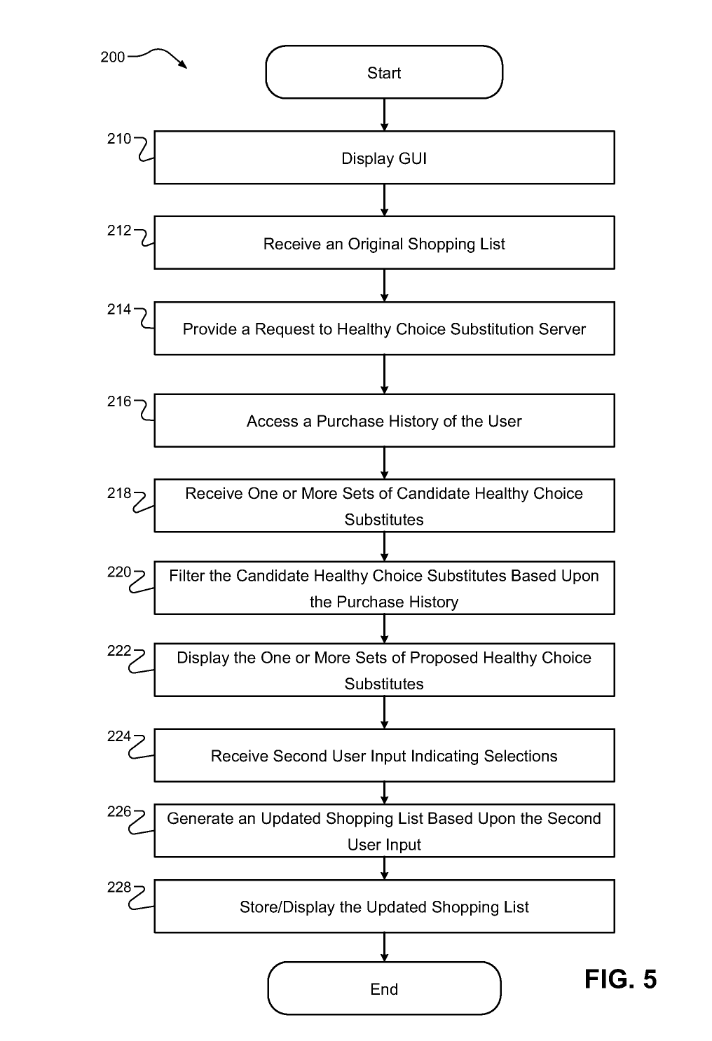

Referring now to FIG. 5, an exemplary method 200 for determining an updated shopping list is illustrated. In some embodiments, the healthy choices substitution module within a portable computerized device executes method 200. In another embodiment, modules within remote server 20 can execute method 200. In another embodiment, portions of method 200 can be operated each in a portable computerized device and in a remote server. At operation 210, a banner announcing operation of a substitution mode is displayed upon a GUI visible to the consumer. As discussed above, the GUI allows the user, either previous to the operation of the substitution mode or as part of the substitution mode, to enter an original shopping list that includes one or more items. At operation 212, the GUI receives the original shopping list.

At operation 214, the healthy choices substitution module 110 provides the electronic shopping list to the remote server. The healthy choices substitution module 110 may provide the electronic shopping list to the remote server at the command of the user. For example, the user may provide user input by pressing, or otherwise selecting, a “one-tap” button displayed in the GUI. In response to the user input, the healthy choices substitution module 110 communicates the electronic shopping list to the remote server 20 over the network 30. At operation 216 a purchase history of the consumer is accessed in order to provide more useful proposed substitutes for the current original shopping list.

At operation 218, the healthy choices substitution module 110 receives one or more sets of candidate substitutes. Each set of proposed substitutes corresponds to one of the items. Thus, if N items were provided to the remote server, the healthy choices substitution module 110 may receive up to N sets of recommended substitutes. In one embodiment, more than N set of proposed substitutes can be provided, for example, if bread, peanut butter, and jelly are included in the original shopping list with N equal to three, the system can propose substitutes for all of the three items and, additionally, can provide a proposed substitute for peanut butter and jelly sandwiches. As indicated previously, one or more of the N sets can be empty sets. The sets of recommended substitutes can be displayed in relation to the items to which they correspond.

At operation 220, healthy choices substitution module 110 filters the list of candidate substitutes based upon the accessed purchase history of the user, according to the methods disclosed herein. At operation 222, the filtered candidate substitutions are provided as proposed substitutions to the user, and at operation 224 the user provides user input to the proposed substitutions to indicate which are accepted and which are rejected. Based upon the user input at operation 224, an updated shopping list is generated at operation 226.

The method 200 of FIG. 5 is provided for example and not intended to be limiting. It should be appreciated that the method 200 may include additional operations and some operations may be varied without departing from the scope of the disclosure.

Methods disclosed herein include providing a proposed substitute for an item on a shopping list. In another alternative, the user can be prompted that an identified item is not very healthy, and the user can be encouraged to simply delete the item from the shopping list.

A shopping list can be generated by simple inputs from a user. In other embodiments, a shopping list can be automatically generated by other methods not disclosed herein, for example, based upon price comparisons. Such automatic shopping list generation methods can be improved by the methods disclosed herein, for example, by adjust weights that the automated system applied to creating shopping lists. If one product is ten cents cheaper than a second product, but the second product has half the sodium of the first product, the selection of one product over the other can be influenced by the health related attributes, as disclosed herein.

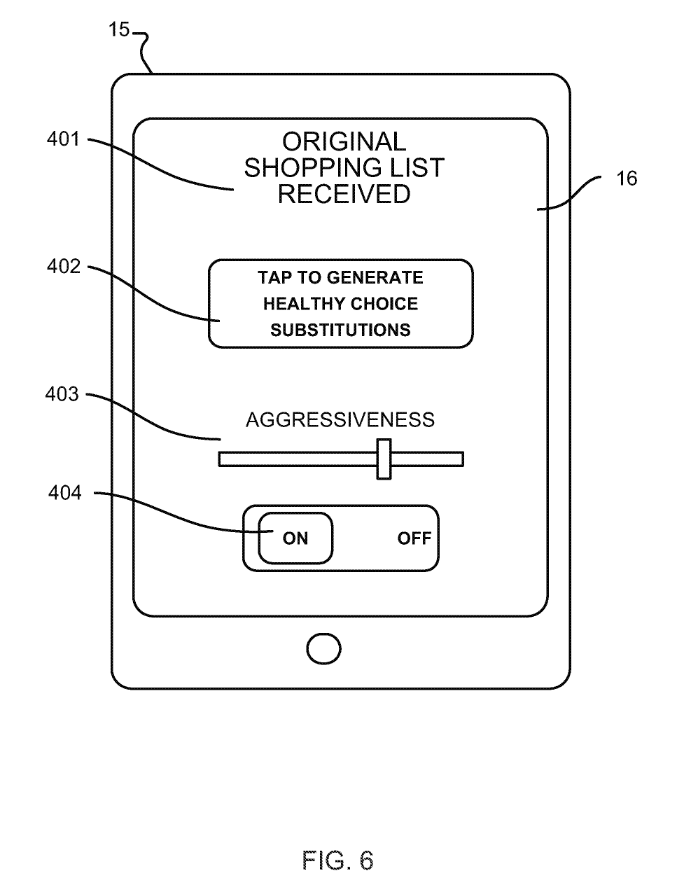

FIG. 6 is a schematic illustrating operation of a one tap button and an aggressiveness slider for generating substitutes for an original shopping list. Portable computerized device 15 including GUI 16 embodied as a tablet computer is illustrated. Banner 401 announces to the user that an original shopping list has been received. Substitutions of healthy products for less healthy products can include detailed product by product questions. Some consumers prefer simple applications. Button 402 provides the user with a one tap execution, wherein methods disclosed herein are employed, and an updated list is automatically generated based upon an original shopping list. Aggressiveness slider 403 is provided to enable the user an ability impact how much the original shopping list can be altered through the substitutions. On/off slider 404 is provided to enable the consumer user to easily activate or deactivate the substitution mode. Upon generation of an automatically generated list include substitutions, an undo button can be provided to the user, for example, to return to the original list, adjust the aggressiveness slide, and attempt the substitutions again.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A computer-implemented method comprising:
receiving from a user, in a computerized device, an original shopping list comprising a consumable product;
determining, in the computerized device, health related attributes for the product;
generating, in the computerized device, a proposed healthy choice substitute for the product based upon the health related attributes; and
displaying the proposed healthy choice substitute to the user.

2. The computer-implemented method of claim 1, further comprising:
receiving from the user, in the computerized device, the original shopping list comprising a plurality of consumable products;
determining, in the computerized device, health related attributes for the plurality of products;
generating, in the computerized device, sets of proposed healthy choice substitutes for a portion of the plurality of products based upon the health related attributes; and
displaying the proposed healthy choice substitutes to the user.

3. The computer-implemented method of claim 2, wherein displaying the proposed healthy choice substitutes comprises displaying the proposed healthy choice substitutes to the user for selection as substitutes to the respective products from the original shopping list;
further comprising:
monitoring a user input to the displayed proposed healthy choice substitutes; and
generating an updated shopping list based upon the user input.

4. The computer-implemented method of claim 3, further comprising:
monitoring the user inputs over time through a series of iterations of original shopping lists; and
adjusting, in the computerized device, the generation of the sets of proposed healthy choice substitutes based upon the user inputs monitored over time.

5. The computer-implemented method of claim 4, wherein adjusting the generation of the sets of proposed healthy choice substitutes comprises utilizing a machine learning algorithm to analyze the user inputs monitored over time.

6. The computer-implemented method of claim 2, further comprising:
storing user preferences regarding the generation of the sets of proposed healthy choice substitutes; and
limiting, in the computerized device, a quantity of the sets of proposed healthy choice substitutes based upon the stored user preferences.

7. The computer-implemented method of claim 2, further comprising:
storing user preferences regarding the generation of the sets of proposed healthy choice substitutes; and
limiting, in the computerized device, a diversity between one of the proposed healthy choice substitutes and a corresponding product from the original shopping list based upon the stored user preferences.

8. The computer-implemented method of claim 2, further comprising:
analyzing, in the computerized device, the plurality of consumable products from the original shopping list to identify a probable recipe intended by the user;
determining, in the computerized device, health related attributes for the probable recipe;
generating, in the computerized device, a set of proposed healthy choice substitute recipes for the probable recipe based upon the health related attributes; and
displaying the proposed healthy choice substitute recipes to the user.

9. The computer-implemented method of claim 2, further comprising:
displaying to the user a summary of health related benefits achieved based upon the proposed healthy choice substitutes.

10. The computer-implemented method of claim 1, further comprising:
requesting, in the computerized device, feedback from the user regarding the proposed healthy choice substitute; and
adjusting, in the computerized device, subsequent sets of proposed healthy choice substitutes based upon the requested feedback.

11. The computer-implemented method of claim 1, wherein determining the health related attributes for the product comprises determining for the product a health related attribute selected from
calories per serving of the product,
fat per serving of the product,
carbohydrates per serving of the product,
simple carbohydrates per serving of the product,
sugar per serving of the product,
protein per serving of the product,
fiber per serving of the product, and
sodium per serving of the product.

12. A computerized application operable upon a computerized device, the application configured to:
in the computerized device,
monitor an original shopping list of a user including a plurality of consumable products,
reference health related attributes for the consumable products,
propose, through a graphical display of the computerized device, an update to the original shopping list based upon the referenced health related attributes.

13. The computerized application of claim 12, wherein the application is further configured to, in the computerized device, present to the user a one tap button to generate the proposed update.

14. The computerized application of claim 12, wherein the application is further configured to, in the computerized device, present to the user an aggressiveness slider to affect the proposed update.

15. A healthy choice substitution server having a processing device, the substitution server comprising:
a healthy choice substitution module configured to:
a) receive an item from an original shopping list from a remote portable computerized device, the item indicating a consumable product,
b) determine health attributes for the item, and
c) determine one or more proposed substitutes for the item based upon the determined health attributes.

16. The server of claim 15, further comprising a substitution database configured to stores a list of candidate substitutes for a plurality of items; and
wherein the healthy choice substitution module is further configured to determine the one or more proposed substitutes for the item further based upon the list of candidate substitutes.

17. The server of claim 15, further comprising a dietary algorithm module configured to process a plurality of shopping lists of the user; and
wherein the healthy choice substitution module is further configured to determine the one or more proposed substitutes for the item further based upon the processed shopping lists.
